(19) United States
(12) Patent Application Publication
(10) Pub. No.: US 2025/0207644 A1
(43) Pub. Date: Jun. 26, 2025

(54) PROTECTIVE DEVICES AND ASSEMBLIES FOR VEHICLES, BICYCLES AND COMPONENTS THEREOF

(71) Applicant: ORUCASE, LLC, San Diego, CA (US)

(72) Inventors: Isaac W. Howe, San Diego, CA (US); Colin S. Jaskiewicz, San Diego, CA (US)

(21) Appl. No.: 18/988,711

(22) Filed: Dec. 19, 2024

Related U.S. Application Data
(60) Provisional application No. 63/613,530, filed on Dec. 21, 2023.

(51) Int. Cl. F16D 65/00; B62J 23/00

(52) U.S. Cl. CPC F16D 65/0081; B62J 23/00

(57) ABSTRACT

Protective assemblies for a disc brake rotor of a vehicle is provided herein. The assembly can include a cover having an end wall and a side wall extending from the end wall, wherein the end wall comprises a first surface and a second surface opposite the first surface. The assembly can further include one or more of a rod, a first cap, and a second cap. In some embodiments, the rod extends between the first cap and the second cap. In some embodiments, the rod extends at least partially through an opening of the cover. In some embodiments, the first cap has a fastening component that extends through an opening of the cover, and the fastening component removably couples to an end of a rod.

### CROSS-REFERENCE TO RELATED APPLICATIONS

This application claims priority to U.S. Provisional Patent Application Ser. No. 63/613,530, filed Dec. 21, 2023. This and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### FIELD

The present disclosure relates generally to devices, assemblies, and methods for protection of disc brake rotors, as well as for protecting bicycles and components thereof, including disc brake rotors.

### BACKGROUND

Disc brake rotors are important components of many bicycles that can mount to a hub of a bicycle wheel and provide a braking surface. The rotors come in a wide variety of sizes suitable for different terrains and riding styles. The rotors can be sized and designed based on, for example, the desired level of braking power, resistance to warping, weight, and/or heat dissipation capabilities. Disc brake rotors tend to be thin and can become damaged and/or bent over time, especially during travel. Some bicycle owners take the rotors off of their wheels and place them between rigid boards in an effort to avoid having them become bent or warped. However, such methods are inconvenient and often do not provide sufficient protection.

### SUMMARY

Accordingly, devices, assemblies, and methods for protection of disc brake rotors of vehicles, as well as protection of bicycles and components thereof, including disc brake rotors, are provided herein. There are no known devices or assemblies for protecting a disc brake rotor from bending without removal of rotor from the wheel. Known devices, such as Muc-Off Disc Brake Cover-Bolt, which can be placed without removal of the rotor from the wheel, are made of a soft fabric/neoprene and Velcro. While such device would potentially provide protection against overspray, such devices would not provide any protection from bending and/or other damage. In contrast, the devices described herein advantageously provide protection of the disc brake rotor from bending or otherwise being damaged, whether used indoors or outdoors, without the need to disassemble any bicycle component. While the application generally describes assemblies and methods for the protection of disc brake rotors on bicycles, it should be appreciated that the assemblies and methods may be used for any disc brake for slowing and stopping of any vehicle in motion. The assemblies and methods described may be especially beneficial for vehicles having a thin metal disc brake.

In an aspect of the disclosure, a protective device for a disc brake rotor of a bicycle is provided, comprising a cover having an end wall and a side wall extending from the end wall, wherein the end wall comprises a first surface and a second surface opposite the first surface, and wherein the end wall includes an opening through the first surface and the second surface.

In some embodiments, the protective device further comprises a rod comprising a first end and a second end, a first cap comprising a first handle portion and a first fastening portion, wherein the first fastening portion is sized and dimensioned to be positioned at least partially through the opening of cover, and wherein the fastening portion is configured to couple to the first end of the rod, and a second cap comprising a second handle portion and a second fastening portion, wherein the second fastening portion is configured to couple to the second end of the rod.

In some embodiments, the protective device further comprises a set of ribs positioned on the first surface of the end wall of the cover. In some embodiments, the side wall comprises an annular side wall. In some embodiments, the cover is a single piece. In some embodiments, the cover and the set of ribs are a single piece. In some embodiments, each rib of the set of ribs extends radially from a central ring-shaped piece. In some embodiments, the set of ribs and the central ring-shape piece are formed from a single piece of material. In some embodiments, at least a portion of the cover is made at least in part of a metal and a plastic. In some embodiments, the end wall and the side wall are made of different materials.

In some embodiments, when the protective assembly is assembled with respect to the bicycle, the rod extends through a hub of a wheel of the bicycle, the handle portion of the first cap is positioned adjacent the first surface of the cover, and the second cap is positioned on an opposite side of the cover such that the cover is positioned between the handle portion of the first cap and the second cap. In some embodiments, the first fastening portion comprises a first opening or recessed portion sized and dimensioned to receive the first end of the rod, and wherein the second fastening portion comprises a second opening or recessed portion sized and dimensioned to receive the second end of the rod, and wherein the first opening or recessed portion and the first end of the rod comprise complementary threads, and wherein the second opening or recessed portion and the second end of the rod comprise complementary threads.

In another aspect of the disclosure, a protective device for a disc brake rotor of a vehicle, for example, a bicycle is provided. The protective device comprises a brake rotor cover having an end wall and a side wall extending from the end wall, wherein the end wall comprises a first surface and a second surface opposite the first surface, and wherein the end wall includes an opening through the first surface and the second surface, and a first cap comprising a first handle portion and a rod, wherein the rod is sized and dimensioned for placement through the opening of the cover and through at least a portion of an opening or recess of a hub of a wheel of the bicycle.

In some embodiments, the rod comprises a compressible material and is configured to be affixed to the opening or recess of the hub. In some embodiments, an end portion of the rod comprises a first threaded portion corresponding to a second threaded portion within the first opening or recess of the hub. In some embodiments, the rod comprises a first fastener component corresponding to a second fastener component of at least one of the hub and a second cap. In some embodiments, the rod is sized and dimensioned to extend through the entire opening of the hub, and wherein an end portion of the rod comprises a first threaded portion corresponding to a second threaded portion of a second cap. Other advantages and benefits of the disclosed devices, assemblies, and methods will be apparent to one of ordinary skill with a review of the following drawings and detailed description.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1A illustrates a portion of a cover of a protective device, according to an embodiment;

FIG. 1B illustrates another view of the cover of FIG. 1A;

FIG. 1C illustrates yet another view of the cover of FIG. 1A;

FIG. 2A illustrates a first cap, according to an embodiment;

FIG. 2B illustrates another view of the first cap of FIG. 2A;

FIG. 2C illustrates yet another view of the first cap of FIG. 2A;

FIG. 3A illustrates a second cap, according to an embodiment;

FIG. 3B illustrates another view of the second cap of FIG. 3A;

FIG. 3C illustrates yet another view of the second cap of FIG. 3A;

FIG. 4A illustrates a protective assembly, according to an embodiment;

FIG. 4B illustrates another view of the protective assembly of FIG. 4A;

FIG. 5A illustrates a protective assembly removably affixed to a bicycle wheel, according to an embodiment;

FIG. 5B illustrates another view of the protective assembly of FIG. 5A removably affixed to the bicycle wheel;

FIG. 6A illustrates another protective assembly removably affixed to another bicycle wheel, according to an embodiment;

FIG. 6B illustrates another view of the protective assembly of FIG. 6A removable affixed to the bicycle wheel;

FIG. 6C illustrates yet another view of the protective assembly of FIG. 6A removably affixed to the bicycle wheel;

FIG. 7A illustrates another protective assembly removably affixed to another bicycle wheel, according to yet another embodiment;

FIG. 7B illustrates another view of the protective assembly of FIG. 7A removably affixed to the bicycle wheel;

FIG. 8A illustrates a bridge device, according to an embodiment;

FIG. 8B illustrates another view of the bridge device of FIG. 8A;

FIG. 9A illustrates a protective device, according to another embodiment;

FIG. 9B illustrates another view of the protective device of FIG. 9A; and

FIG. 10 illustrates a side view of a cover of another protective device, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description. Some of the surfaces have been left out or exaggerated for clarity and case of explanation.

According to one aspect of the disclosure, a protective device for a vehicle wheel, for example, a bicycle wheel component (e.g., a disc brake rotor) is provided, comprising a cover having an end portion and a side portion extending from the end portion. The end portion can also be described as an end plate or end wall, and the side portion can also be described as a side wall. In some embodiments, the side wall is an annular side wall that forms a loop. In some embodiments, the annular side wall is rounded (e.g., circular, oval). In some embodiments, the side wall is ring shaped. In some embodiments, the side wall is polygonal or has an irregular shape.

In some embodiments, the end portion can comprise a first surface (e.g., an outer surface facing away from the rotor) and a second surface (e.g., an inner surface facing the rotor) opposite one another. In some embodiments, one of both surfaces can comprise a set of ribs (e.g., at least 1, at least 2, at least 3, at least 4, at least 5 ribs). In some embodiments, the end portion can comprise an opening that extends through and between the first and second surface. The opening can comprise a through-hole. In some embodiments, the end portion and the side portion are made of different materials. In some embodiments, the cover is made of a single piece of material. In some embodiments, the cover is made of multiple pieces of material. In some embodiments, at least a portion of the cover is made at least in part of a hard plastic. In some embodiments, at least a portion of the cover is made at least in part of an Acrylonitrile butadiene styrene (ABS). In some embodiments, at least a portion of the cover is made at least in part of a Nylon polypropylene.

According to another aspect, a protective device for a vehicle wheel, for example, a bicycle wheel component (e.g., a disc brake rotor) is provided, comprising a cover having an end portion and a side portion extending from the end portion, wherein the side portion comprises an annular side wall that forms a loop (which does not have to be rounded or circular). In some embodiments, the side wall or at least a portion of the side wall is elastic and configured to stretch, for example, to expand to fit over a disc brake rotor. In some embodiments, the side wall is generally rigid and has one or more elastic portions.

According to another aspect of the disclosure, a protective assembly for a vehicle wheel, for example, a bicycle wheel component (e.g., a disc brake rotor) is provided, comprising a cover having an opening, and a first cap comprising a handle portion and a fastening portion, wherein the fastening portion is sized and dimensioned to extend through and/or be positioned through the opening. In some embodiments, the cover can comprise any of the covers of the protective devices described above. In some embodiments, the cover further comprises an end portion, and a side portion extending from the end portion. In some embodiments, the end portion has a first surface and a second surface opposite one another and wherein the first surface comprises a set of ribs, and wherein the annular side wall extends from the second surface. In some embodiments, the side wall extends perpendicularly relative to a length of the second surface. In some embodiments, the end portion comprises the opening, and the opening extends through and between the first surface and the second surface.

In some embodiments, the end portion and the side portion are made of different materials. In some embodiments, the cover is made of a single piece of material. In some embodiments, at least a portion of the side portion is elastic and configured to stretch around and over an edge of the bicycle wheel component.

In some embodiments, the assembly further comprises a rod (e.g., a metal rod, a plastic rod) sized and dimensioned to extend fully and/or at least partially through a hub of a bicycle wheel. In some embodiments, the fastening portion of the first cap comprises a recess or opening sized and dimensioned to receive a first end of the rod. In some embodiments, the assembly further comprises a second cap comprising a second fastening portion, wherein the second fastening portion of the second cap comprises a second recess or opening sized and dimensioned to receive a second end of the rod. In some embodiments at least one of the fastening portions can comprise threading (e.g., on an outer surface, within a receiver, an opening or recessed portion). While the disclosure herein describes threaded fasteners for coupling different components together (e.g., an end of a rod to a cap, rod to hub), it should be appreciated that other fasteners are also contemplated.

For example, different components can removably couple to one another via a snap fit, cantilever snap fit including one or more levers or pins to be pushed in order to undo a snap, pin through openings, annular snap fit components, or torsional snap fit components, etc. As an example, a rod can comprise a button or lever that can be depressed or pushed towards a release position. The button or lever may be biased towards an engaged position. In some embodiments, a fastening portion of a cap can comprise an opening sized and dimensioned to receive the button or lever when button or lever is in an engaged position (not depressed or pushed down). The rod can be removed from the fastening portion by pushing down the button or lever, moving it into a release position and then separating the rod and the fastening portion. Any other suitable fasteners are also contemplated. In some embodiments, two or more items (e.g., end portion of a rod and a fastening portion of a cap) can be press fit together.

In some embodiments, the first fastening portion of the first cap comprises a rod sized and dimensioned for placement through at least a portion of a first opening or recess of a hub of a bicycle wheel to secure the cover over the bicycle wheel component. In some embodiments, the rod of the first cap comprises a first fastening component corresponding to a second fastening component of the hub. In some embodiments, the rod of the first cap comprises a first threaded portion corresponding to a second threaded portion within the first opening or recess of the hub. In some embodiments, the first threaded portion comprises male threads and the second threaded portion comprises female threads.

In some embodiments, the assembly further comprises a second cap comprising a second handle portion and a second fastening portion. In some embodiments, the assembly further comprises a rod sized and dimensioned to extend through a hub of a bicycle wheel (e.g., in place of an axle). In some embodiments, the first cap is configured to attach to a first end of the rod, and wherein the second cap is configured to removably attach to a second end of the rod. In some embodiments, the assembly further comprises a rod sized and dimensioned to extend through a hub of a bicycle wheel, wherein the first cap is configured to removably attach to a first end of the rod, and the second cap is configured to attach to a second end.

In some embodiments, the assembly further includes a rod sized and dimensioned to extend through a hub of a wheel, the first cap is attached to a first end of the rod, and the second cap is configured to removably attach to a second end. In some embodiments, a rod sized and dimensioned to extend through a hub, the first cap is configured to removably attach to a first end of the rod, and the second cap is attached to a second end of the rod.

According to another aspect of the disclosure, a protective assembly for a vehicle wheel, for example, a bicycle wheel component (e.g., a disc brake rotor) is provided, comprising a cover having an opening, and a first cap comprising a handle portion and a fastening portion, wherein the fastening portion is sized and dimensioned to extend through and/or be positioned through the opening, and wherein the fastening portion of the cap has a soft or compressible portion that has a diameter greater than a diameter of a first opening of a hub, but is configured to compress to fit within the first opening of the hub of a bicycle wheel to secure the cover over the discs brake rotor.

According to another aspect of the disclosure, a protective assembly for a disc brake rotor has a cover with a first surface and a second surface, and a fastening component extending from the second surface and including a compressible portion that has a diameter greater than a diameter of a first opening of a hub, but is configured to compress to fit within the first opening of the hub of a bicycle wheel to secure the cover over the bicycle wheel component. In some embodiments, the first surface comprises a set of ribs. In some embodiments, the cover has an annular side wall.

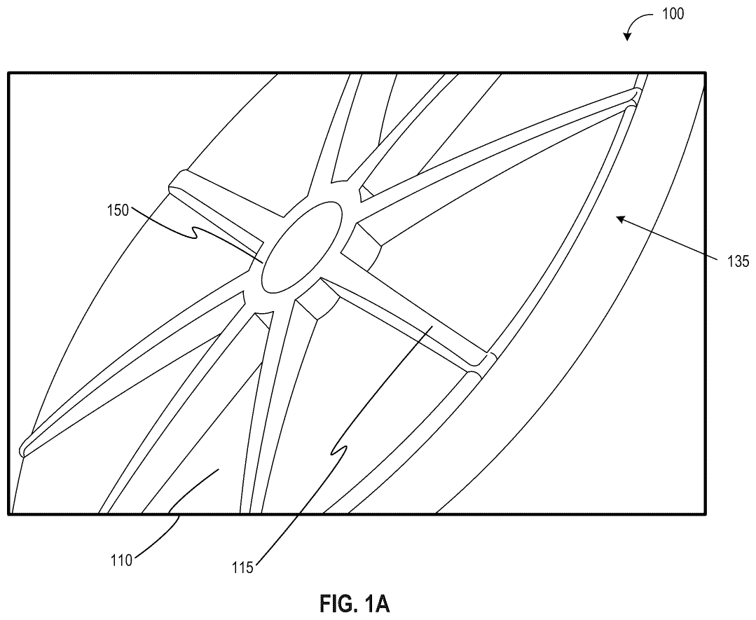

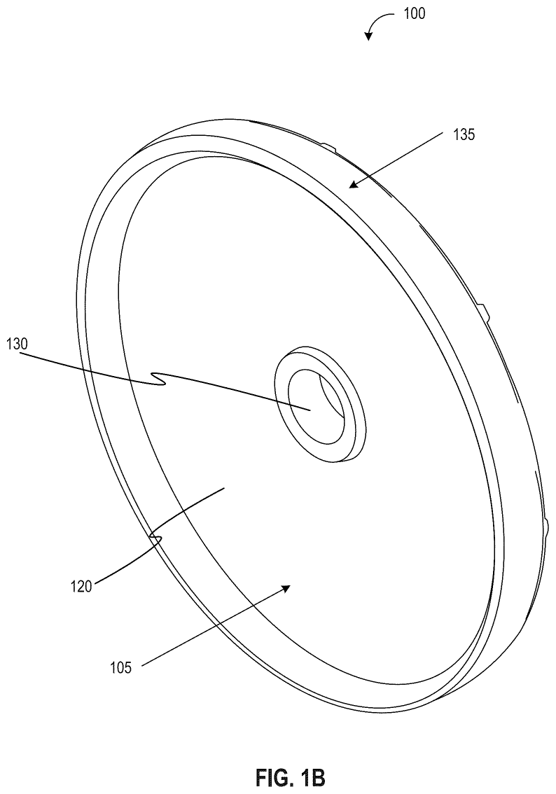

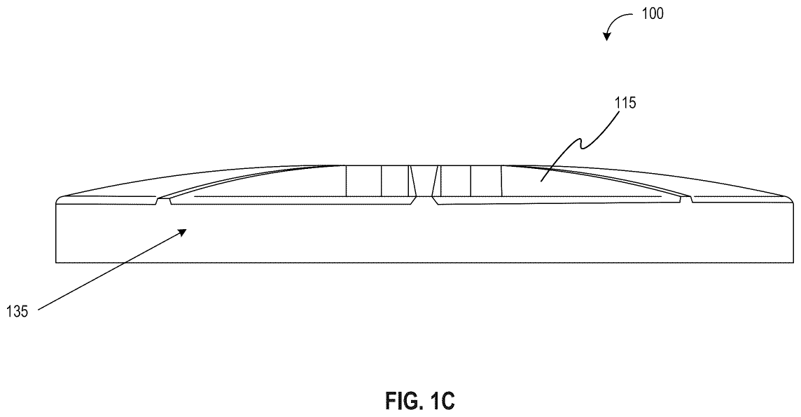

FIGS. 1A-1C illustrate a cover of a protective device, according to an embodiment. Cover 100 can comprise an end portion 105, sometimes referred to herein as an end plate or end wall, and a side portion 135, sometimes referred to herein as a side wall.

Side portion 135 can comprise a side wall that extends away from the end portion 105. For example, side portion 135 can extend substantially perpendicular to the end portion. In some embodiments, side portion 135 is a continuous annular wall that extends substantially perpendicular to, and away from, the end wall. In some embodiments, side portion 135 is a continuous annular wall that extends substantially perpendicular to, and away from, an outer edge portion of the end wall. In some embodiments, side portion 135 is a continuous annular wall that extends substantially perpendicular to, and away from, a non-central portion of the end wall. In some embodiments, side portion 135 is a ring-shaped piece that extends substantially perpendicular to, and away from, the end wall, for example, an outer edge portion of the end wall, or other non-central portion of the end wall. While the description herein is directed to covers that have a continuous side wall extending from the periphery of the end portion, it should be appreciated that all suitable side walls are contemplated herein, including those that are not continuous and/or include multiple side wall pieces.

End portion 105 comprises a first surface 110, which can be considered an outer surface, and a second surface 120, which can be considered an inner surface. First surface 110 comprises a set of ribs 115 that provide additional rigidity to cover 100, and thus additional protection to the disc brake rotor when cover 100 is placed over the disc brake rotor or portion thereof. Cover 100 comprises an opening 130 extending through the end portion 105, including first surface 110 and second surface 120. Opening 130 can be sized and dimensioned to receive a portion of a cap, which is further described herein. Opening 130 can be positioned centrally through end portion 105. Any suitable number of ribs 115 can be provided on a cover (e.g., at least 2, at least 4, at least 5, at least 6, at least 8, at least 9, at least 10, between 5-10). In some embodiments, each rib of the set extends radially from a central piece. In FIGS. 1A-IC, set of ribs 115 extend radially from a central ring-shaped piece 150, wherein the opening of the central ring-shaped piece at least partially aligns with opening 130. While opening 130 and central ring-shaped piece are each shown as circular, it should be appreciated that opening 130 and the opening of the central ring-shaped piece 150 can comprise any suitable shape (e.g., oval, irregular, polygonal).

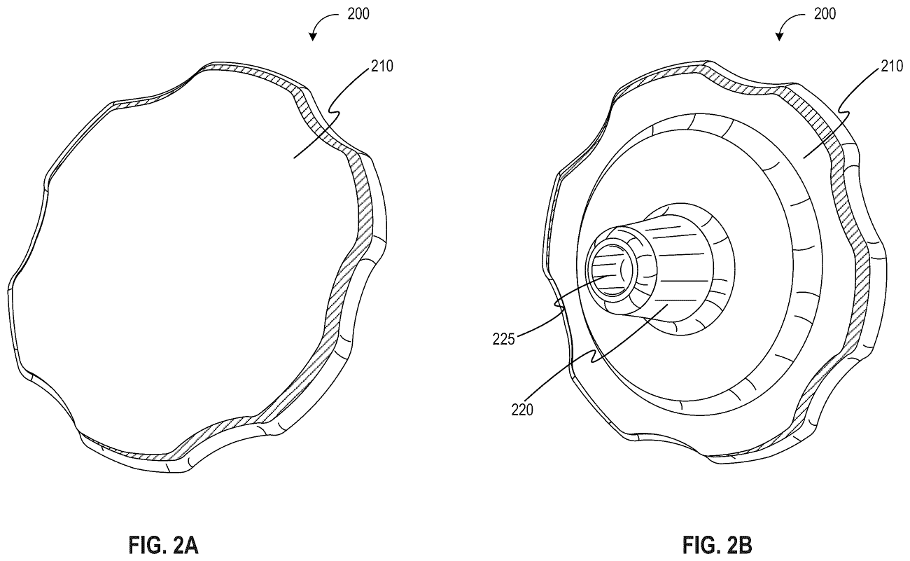

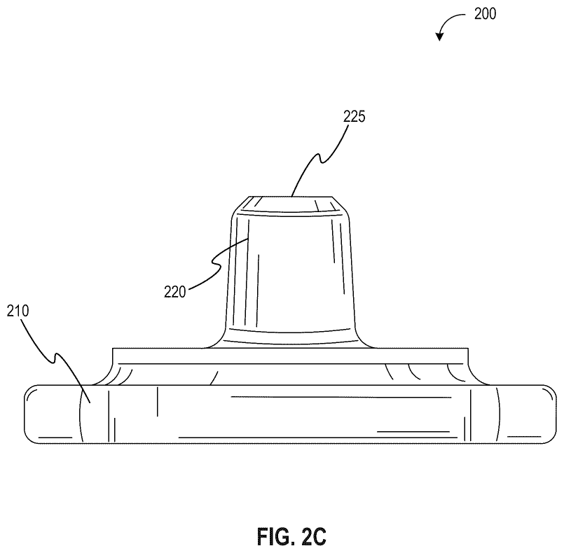

FIGS. 2A-2C illustrate a first cap, according to an embodiment. First cap 200 comprises handle portion 210, and a fastening portion 220 comprising a receiver 225, which can be, for example, an opening or recessed portion. In some embodiments, a handle portion can comprise a shape suitable for a user to grab and twist or otherwise adjust the first cap. In some embodiments, fastening portion 220 is sized and dimensioned to extend at least partially through an opening of a cover (e.g., opening 130 of the cover 100). In some embodiments, fastening portion 220 is sized and dimensioned to extend at least partially through both an opening of a cover and a ring-shaped piece from which a set of ribs extend radially (e.g., ring-shaped piece that set of ribs 115 extend radially from). In some embodiments, the receiver 225 is sized and dimensioned to secure a rod.

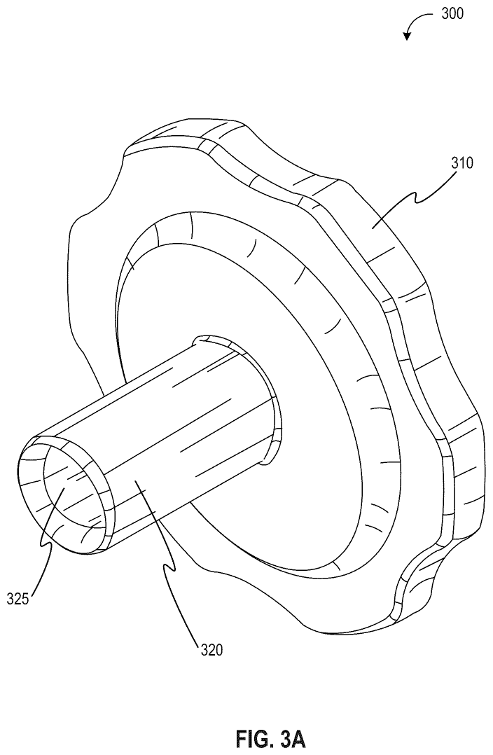

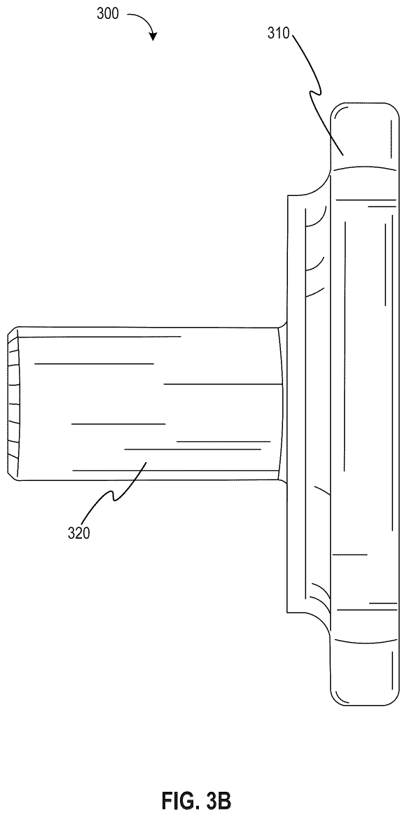

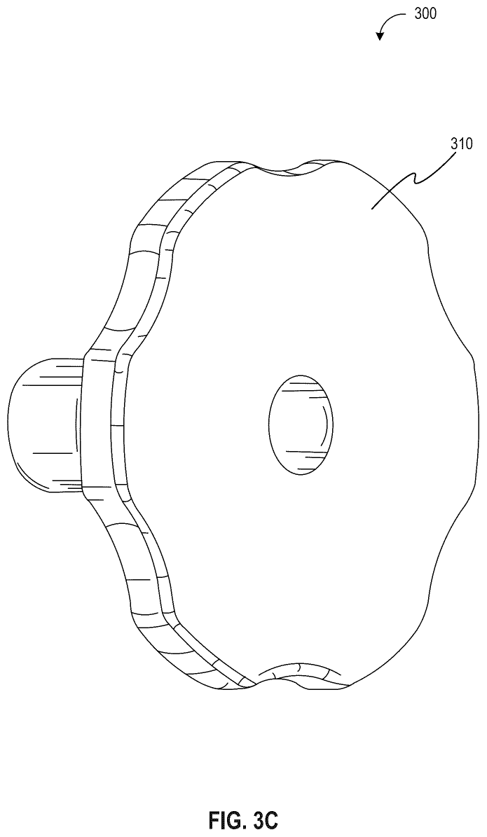

FIG. 3A-3C illustrate a second cap, according to an embodiment. Second cap 300 comprises handle portion 310, and a fastening portion 320 comprising a receiver 325, which can comprise, for example, an opening or a recessed portion. Receiver 225 of first cap 200 can be sized and dimensioned to receive a first end of a rod (e.g., of rod 450), and receiver 325 of cap 300 can be sized and dimensioned to receive a second end of the rod.

In some embodiments, a first end of the rod can include threading, and a second end of the rod can include threading. In some embodiments, receiver 225 can comprise threading that is complementary to the threading of the rod (e.g., threading on the first end of the rod). In some embodiments, receiver 325 can include threading that is complementary to the threading of the rod (e.g., threading on the second end of the rod).

In some embodiments, additionally or alternative to receiver 325, fastening portion 320 could have a compressible portion that is configured to fit through an opening of a hub.

In some embodiments, additionally or alternative to receiver 225, fastening portion 220 can comprise any suitable mechanism to removably couple to a rod. For example, a rod can include a receiver, and an end or tip of fastening portion 220 can be configured to press fit into receiver. As another example, a rod can include a receiver having threading, and an end or tip of fastening portion 220 can comprise a threaded end or tip, wherein the threading of the receiver and the fastening portion are complementary. In some embodiments, an end or tip of a rod can be configured to be press fit in receiver 225.

In some embodiments, additionally or alternative to receiver 325, fastening portion 320 can comprise any suitable mechanism to removably couple to a rod. For example, a rod can include a receiver, and an end or tip of fastening portion 320 can be configured to press fit into receiver. As another example, a rod can include a receiver having threading, and an end or tip of fastening portion 320 can comprise a threaded end or tip, wherein the threading of the receiver and the fastening portion are complementary. In some embodiments, an end or tip of a rod can be configured to be press fit in receiver 325.

In some embodiments, additionally or alternative to receiver 325, fastening portion 320 can comprise any suitable mechanism to removably couple to a hub of a bicycle wheel.

As described herein, a cover (e.g., cover 100), one or more caps (e.g., first cap 200, second cap 300), and a rod can form a protective assembly for protecting a bicycle component (e.g., a disc brake rotor). It should also be appreciated that in some embodiments, a protective assembly has fewer than all of the components described herein. For example, it is contemplated that a cover can include an end wall and a side wall extending from the end wall as described above. In some embodiments, a fastening component is coupled to and/or extends from a surface, for example, the second surface of the cover. In some embodiments, the fastening component is configured to couple to a hub of other aspect of the bicycle wheel via any suitable fastening means. For example, fastening component could comprise a compressible material that can be secured in an opening or recess of a hub. In some embodiments, the fastening component has a larger diameter than the opening or recess of the hub when not compressed, but is configured to compress to fit within such opening or recess of the hub. In some embodiments, the hub or other aspect has a threaded portion configured to removably fasten to a complementary threaded portion of the fastening component. In some embodiments, the end wall lacks an opening.

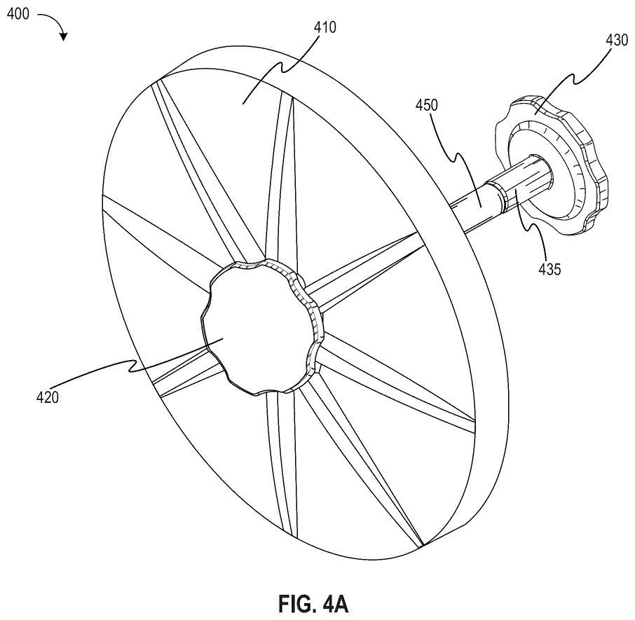

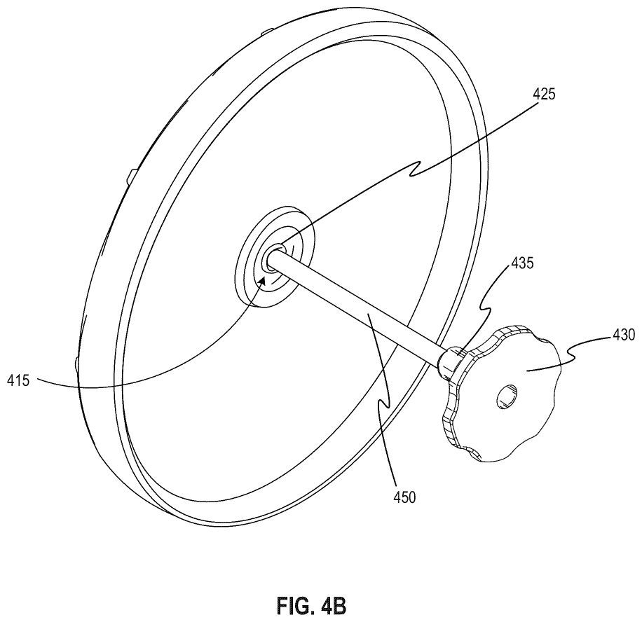

FIGS. 4A-4B illustrate a protective assembly, according to an embodiment, which can be used to protect a disc brake rotor that is part of an assembled wheel. Protective assembly 400 has a cover 410 that includes an opening 415, first cap 420 having a first fastening portion 425, a second cap 430 comprising a second fastening portion 435, and a rod 450 sized and dimensioned to fit through an opening of a bicycle wheel hub.

In some embodiments, opening 415 of cover 410 can be placed over and/or around a first end of rod 450, with the side wall of the cover 410 extending around the edges of the bicycle wheel's metal brake rotor. In some embodiments, the side wall of cover 410 extends beyond the brake rotor so that the side wall surrounds the entire periphery of the brake rotor, while an end wall covers an entire side or face of the disc brake rotor.

First cap 420 can be attached (e.g., removably attached) to a first end of rod 450. Rod 450 and optionally a fastener portion of first cap 420 can be placed through the disc brake rotor axle hole. A second cap 430 can be attached (e.g., removably attached) to a second end of rod 450 such that the end wall of the first cap 420 and the end wall of the second cap 430 are on opposite sides of the axle hole. It should be appreciated that each cap can be configured to attach or couple to an end of the rod in any suitable manner (e.g., press fit, cork press fit, threads). For example, one or both caps can comprise a fastening portion having receiver (e.g., an opening or a recess) sized and dimensioned to receive an end portion of the rod.

In some embodiments, the receiver of a fastening portion of a cap and an end portion of the rod can comprise complementary threading. In some embodiments, the receiver and the end portion can couple via a press fit. In some embodiments, the end portion of the rod can comprise a receiver. In some embodiments, the end portion of the rod can comprise a receiver, and a fastening portion of a cap can press fit into the receiver. In some embodiments, the fastening portion of a cap and a receiver of an end portion of a rod can comprise complementary threading.

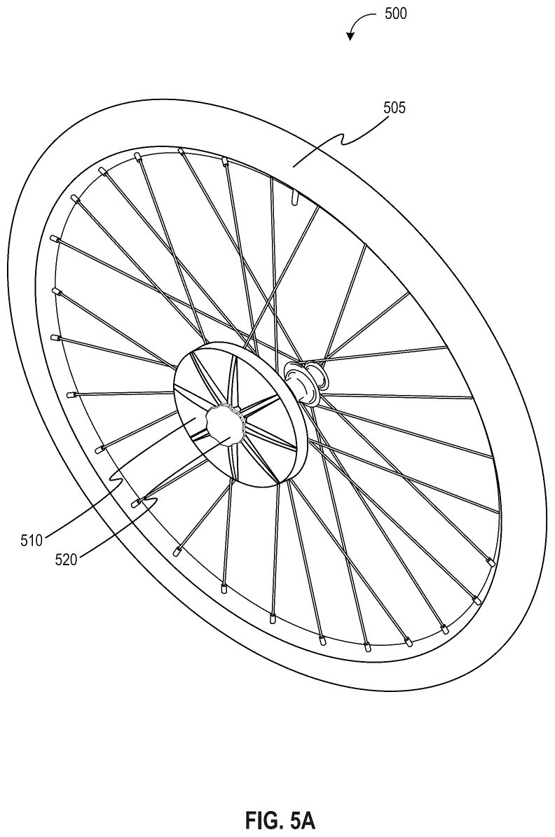

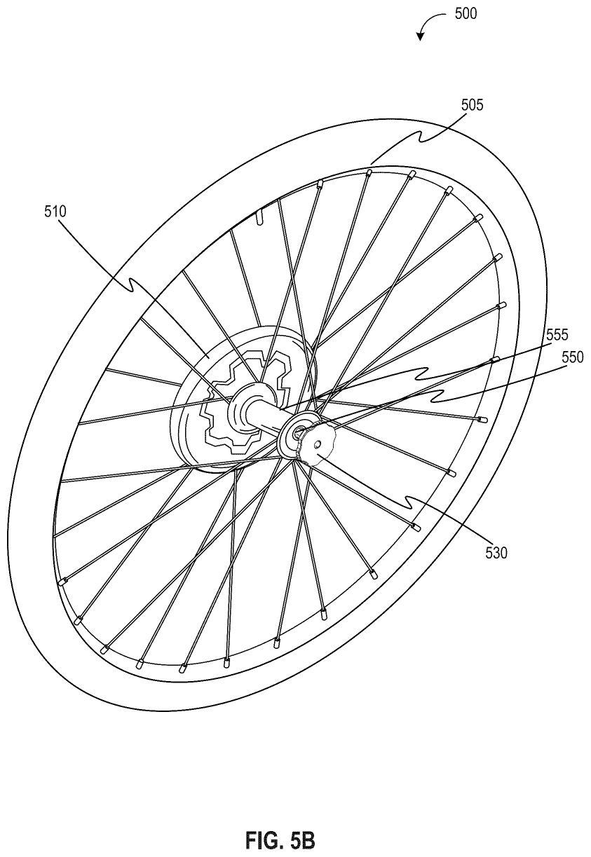

FIGS. 5A-5B illustrate another protective assembly, according to an embodiment, wherein the assembly has been affixed to a bicycle wheel to protect the disc brake rotor. Assembly 500 includes a cover 510 coupled to a wheel 505 via a first cap 520, second cap 530, and a rod 500 extending through hub 555 to provide protection to a disc brake rotor. When assembly 500 is in use it should be appreciated that cover 510 is positioned around at least a portion of the brake rotor and is useful to protect it from bending and from other damage. In some embodiments, assembly 500 can comprise some or all of the components of assembly 400, cover 100, first cap 200, and/or second cap 300.

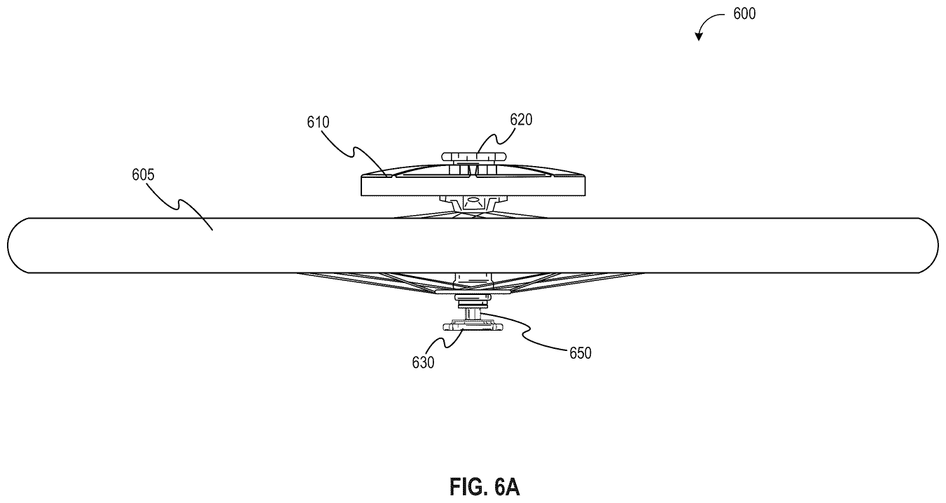

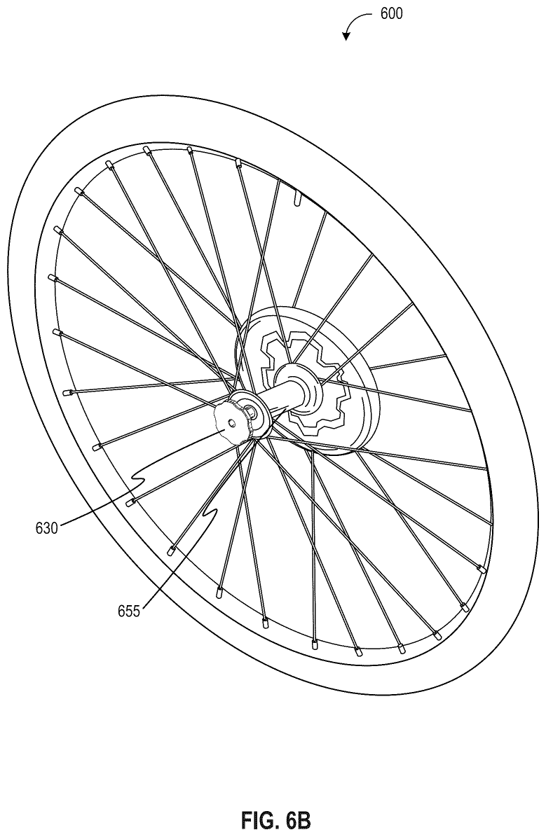

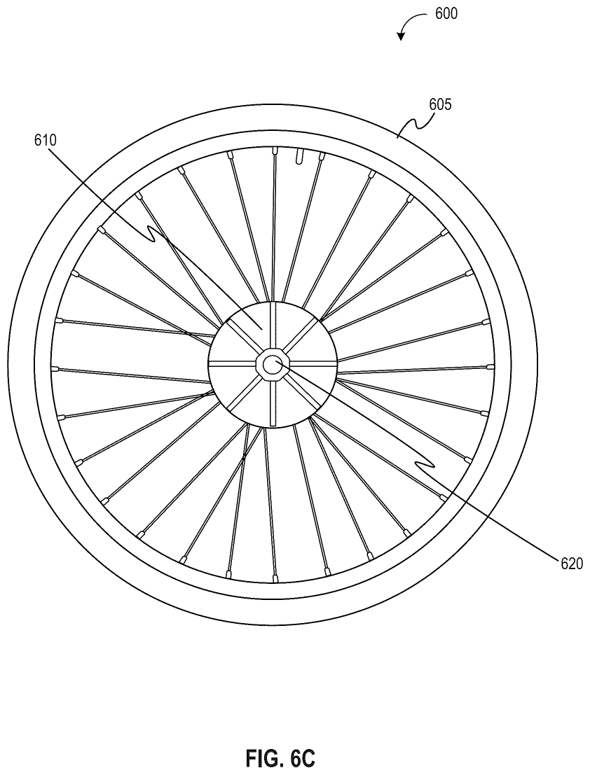

FIGS. 6A-6C illustrate another protective assembly, according to an embodiment, wherein the assembly has been affixed to a bicycle wheel to protect the disc brake rotor. Assembly 600 includes a cover 610 coupled to a wheel 605 via a first cap 620, second cap 630, and a rod 650 extending through hub 655 to provide protection to a disc brake rotor. When assembly 500 is in use it should be appreciated that cover 510 is positioned around at least a portion of the brake rotor and is useful to protect it from bending and from other damage. In some embodiments, assembly 600 can comprise some or all of the components of assembly 400, cover 100, first cap 200, and/or second cap 300.

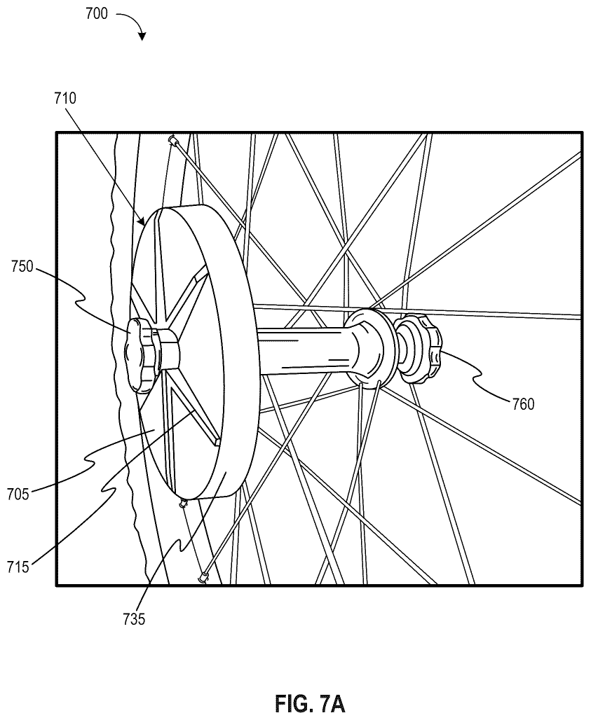

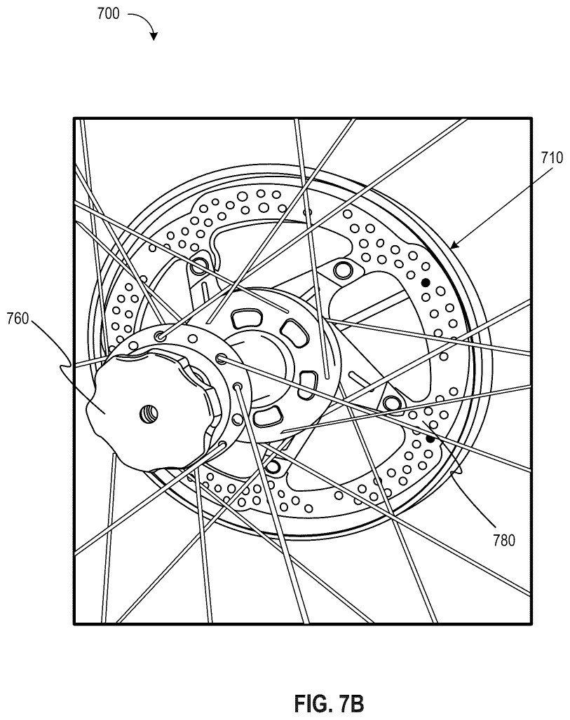

FIGS. 7A-7B illustrate another protective assembly, according to an embodiment, wherein the assembly has been affixed to a bicycle wheel to protect the disc brake rotor 780. Assembly 700 includes a cover 710 coupled to a wheel via a first cap 750, second cap 760, and a rod extending through a hub to provide protection to a disc brake rotor 780. Cover 710 includes an end wall 705 and a side wall 735 extending away from the end wall such that a length of the side wall (from the end wall to the open edge) is substantially perpendicular to a length of the end wall. In some embodiments, assembly 700 can comprise some or all of the components of assembly 400, cover 100, first cap 200, and/or second cap 300.

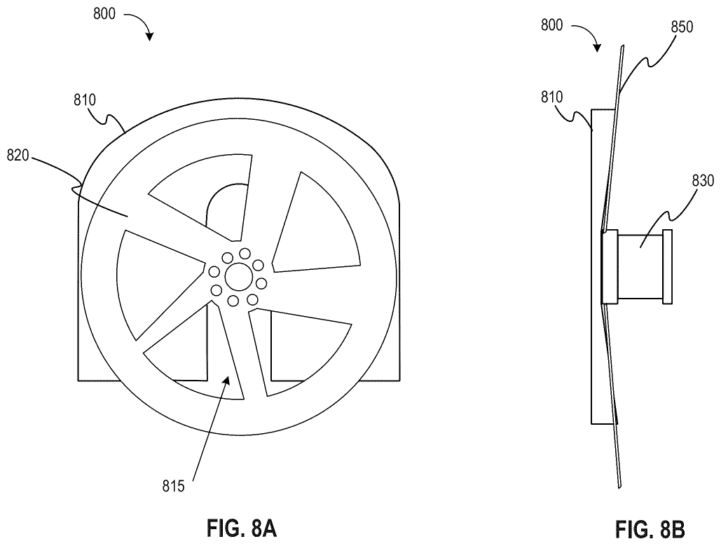

FIGS. 8A-8B illustrate an embodiment 800 where a bridge device 810 is secured between the spokes of a wheel or other component, and a disc brake rotor 820. FIG. 8A shows a view of a surface of the rotor that is opposite the hub of the bicycle. FIG. 8B shows a side view showing the hub and spokes, along with device 810 (rotor not shown). Bridge device 810 can be made of any suitable material, including for example, a plastic, and a dense foam. Bridge device 810 can include a cutout 815, for example an upside down U-shaped cutout as shown in FIG. 8, which allows the bridge device to be wedged between a disc brake rotor 815 and another component (e.g., the spokes 850 on the wheel, hub 830). The bridge stabilizes the discs brake rotor and allows it to better deflect impacts and avoid damage. As shown in FIG. 8B, the bridge device 810 can have a non-uniform thickness. In the example shown, the bridge device is thicker at top and bottom portions, and thinner towards the center. A first side of the bridge device can be substantially flat, similarly to a surface of a disc brake rotor. A second side of the bridge device can be angled to align with the shape of the spokes 850 it is wedged against. In some other embodiments, the bridge device 810 can have a uniform thickness or any other suitable varying thickness.

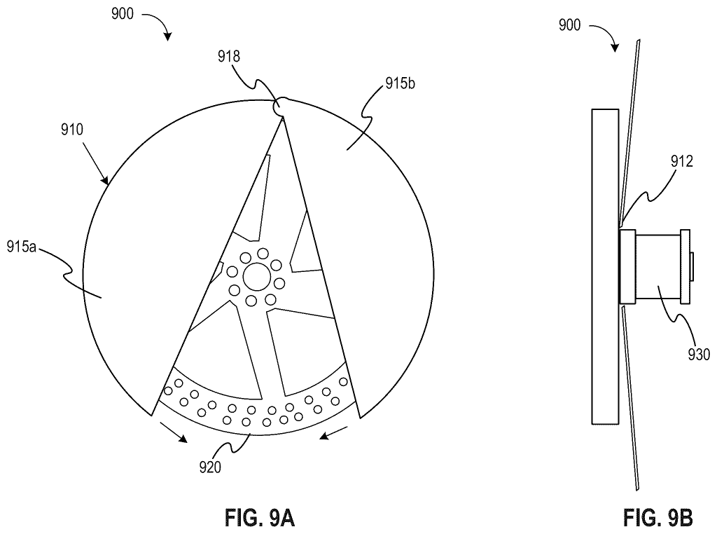

FIGS. 9A-9B illustrates another embodiment 900 where a protective device 910 Is secured over and/or around a disc brake rotor 920. FIG. 9A shows a view of a surface of the rotor that is opposite the hub of the bicycle. FIG. 9B shows a side view showing the hub and spokes, along with device 810 (around rotor 920). Device 910 can be made of any suitable material, and in the example shown, device 910 is made from plastic. Device 910 comprises a first piece 915a and a second piece 915b, which can be viewed as two halves, each of which are sized and dimensioned to cover about half of a rotor 910 (including a front face, a rear face, and side edge). In some embodiments, the two halves can releasably snap together.

In some embodiments, the two pieces can be pivotably or rotatably coupled at one end via a joint 918 at the first ends, and second ends of each of the two pieces can be configured to move between an open and closed configuration, and optionally to be fastened together at the second ends. In an open configuration, the second ends of the two pieces can extend around the periphery of the brake rotor. In a closed configuration, the two halves can enclose the rotor or portion thereof. FIG. 9A includes arrows showing the second ends of the two halves moving from an open configuration to a closed configuration. In some embodiments, the second ends are configured to snap or otherwise fasten together in a closed configuration. As shown in FIG. 9B, device 910 can comprise an opening 912 (e.g., a circular opening formed when the two halves are in a closed configuration), which can be sized and dimensioned to fit snugly against the hub acting as an anchor. This anchor can stabilize device 910, allowing it to deflect any impacts away from the disc.

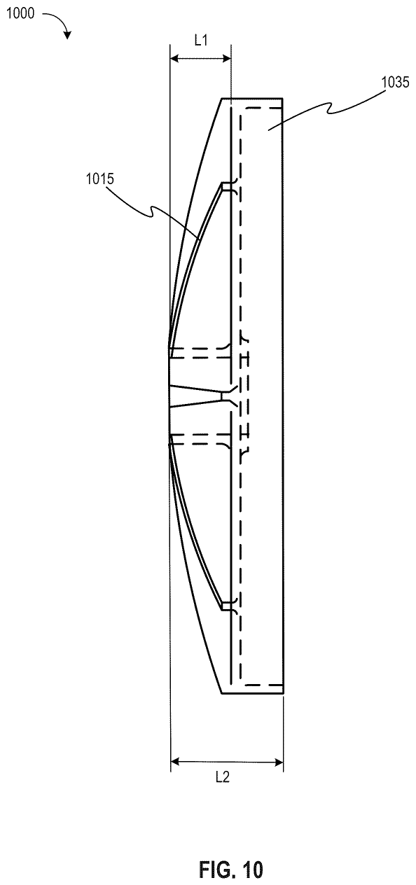

FIG. 10 illustrates another cover 1000 of a protective device having a side portion 1035, and a set of ribs 1015 on a first surface (side facing away from the disc brake rotor). Side portion 1035 is sized and dimensioned to be positioned around the rotor, for example, when cover 1000 is affixed to the bicycle having the disc brake rotor. Here, the set of ribs are shown to have a first length (L1) while the cover has a second length (L2). L2 is larger than L1 as L2 includes a length of cover 1035, in addition to end wall and the set of ribs. L1 may be any suitable length, including for example, between 0.25-1.25 inches, between 0.5-1 inch, between 0.7-0.8 inches, between. 1-1 inch, at least 025 inches, at least 0.5 inches, or any other suitable length. L2 may be any suitable length, including for example, between 0.5-2 inches, between 0.75-1.75 inches, between 1-1.5 inches, between 1.25-1.3 inches, at least 0.75 inches, at least 1 inch, at least 1.1 inches, at least 1.2 inches, at least 1.25 inches, or any other suitable length. Each of the lengths and other dimensions may be selected, for example, for increased compatibility with different styles of bicycles. In some embodiments, L1 may be, for example, between 5-95% of L2, between 10-80% of L2, between 20-60% of L2, between 30-60% of L2, between 40-60% of L2, between 50-60% of L2.

While the covers shown herein generally have a circular shape that is slightly larger than a disc brake rotor, it should be appreciated that protective devices contemplated herein can be of any suitable size and shape. For example, the protective devices can have a cover that has a circular, rectangular, hexagonal, octagonal, irregular, or oval end wall. In some embodiments, a length (or diameter) of the end portion of a cover can be, for example, between 3-12 inches, between 5-10 inches, between 6-9 inches, between 3-10 inches, between 3-8 inches, or any other suitable length. In some embodiments, a second length (or diameter) of the end portion 105 that is perpendicular to the first length can be, for example, between 3-12 inches, between 5-10 inches, between 6-9 inches, between 3-10 inches, between 3-8 inches, or any other suitable length. In some embodiments, a length of the side portion or side wall of a cover (e,g, of a line perpendicular to a length of the end portion, the line extending from the end portion to the open edge) from can be, for example, between 0.25-3 inches, between 0.5-2 inches, 0.25-2.5 inches, between 0.5-1.5 inches, between 0.5-0.75 inches, or any other suitable length. The covers can be made of any suitable material for protecting a disc brake rotor of a bicycle (or other component) from bending during travel, including, for example, a plastic, a hard plastic, a metal, a wood, a composite, a clear plastic, or any other material(s). In some embodiments, the cover includes an elastic side wall.

In some embodiments, a portion or all of the side wall of a cover can be clastic and configured to stretch around and over an edge of a bicycle wheel component (e.g., a rotor).

The first cap, second cap, rod, ribs, and any other component can also be made of any suitable material, and have any suitable size and shape. For example, each cap, the rod, and the set of ribs can be made of the same or different material(s) as the cover and/or one another. In some embodiments, the cover, first cap, second cap, set of ribs, and rod are each made of a plastic (e.g., a hard plastic). In some embodiments, the cover, first cap, second cap, and the set of ribs are each made of a plastic (e.g., a hard plastic), and the rod is metal. A length of the rod can be any suitable length, for example, based on what bike the assembly will be used with. For example, it is contemplated that rods can have an end-to-end length of between 2-10 inches, between 1-7 inches, between 2-6 inches, or any other suitable end-to-end length. It is contemplated that a diameter of the rod can be any suitable diameter, including for example, a diameter of between 0.05-1 inch, 0.1-0.7 inch, or 0.2-0.6 inch. In some embodiments, the length of the rod is adjustable (e.g., telescoping rod, scored rod, cuttable).

Thus, specific examples of protective devices, assemblies and methods for disc brake of a vehicle, or for other bicycle and bicycle components (e.g., disc brake rotor) have been disclosed. The above description of the disclosed embodiments is provided to enable any person skilled in the art to make or use the invention. The preceding detailed description is merely exemplary in nature and is not intended to limit the invention or the application and uses of the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

The illustrations may include exaggerated dimensions and graphical representation to better illustrate the referenced items shown, and are not considered limiting unless expressly stated as such.

In interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps not expressly referenced.

Also, as used herein, and unless the context dictates otherwise, the term “coupled to” is intended to include both direct coupling (in which two elements that are coupled to each other contact each other) and indirect coupling (in which at least one additional element is located between the two elements).

Reference throughout this specification to “an embodiment” or “an implementation” means that a particular feature, structure, or characteristic described in connection with the embodiment is included in at least one embodiment or implementation. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Certain numerical values and ranges may be presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

In the specification, reference may be made to the spatial relationships between various components and to the spatial orientation of various aspects of components as the devices are depicted in the attached drawings. However, as will be recognized by those skilled in the art after a complete reading of the present application, the devices, members, devices, etc. described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Groupings of alternative elements or embodiments of the disclosure herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

All structural and functional equivalents to the components of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A protective device for a disc brake rotor, comprising:
a cover having an end wall and a side wall extending from the end wall, wherein the end wall comprises a first surface and a second surface opposite the first surface, and wherein the end wall includes an opening through the first surface and the second surface;
a rod comprising a first end and a second end;
a first cap comprising a first handle portion and a first fastening portion, wherein the first fastening portion is sized and dimensioned to be positioned at least partially through the opening of the cover, and wherein the fastening portion is configured to couple to the first end of the rod;
a second cap comprising a second handle portion and a second fastening portion, wherein the second fastening portion is configured to couple to the second end of the rod.

2. The protective device of claim 1, further comprising a set of ribs positioned on the first surface of the end wall of the cover.

3. The protective device of claim 1, wherein the side wall comprises an annular side wall.

4. The protective device of claim 1, wherein the cover is a single piece.

5. The protective device of claim 1, wherein the cover and the set of ribs are a single piece.

6. The protective device of claim 1, wherein each rib of the set of ribs extends radially from a central ring-shaped piece.

7. The protective device of claim 6, wherein the set of ribs and the central ring-shape piece are formed from a single piece of material.

8. The protective device of claim 1, wherein at least a portion of the cover is made at least in part of a metal and a plastic.

9. The protective assembly of claim 1, wherein the end wall and the side wall are made of different materials.

10. The protective assembly of claim 1, wherein when the protective assembly is assembled with respect to a bicycle, the rod extends through a hub of a wheel of the bicycle, the handle portion of the first cap is positioned adjacent the first surface of the cover, and the second cap is positioned on an opposite side of the cover such that the cover is positioned between the handle portion of the first cap and the second cap.

11. The protective assembly of claim 1, wherein the first fastening portion comprises a first opening or recessed portion sized and dimensioned to receive the first end of the rod, and wherein the second fastening portion comprises a second opening or recessed portion sized and dimensioned to receive the second end of the rod, and wherein the first opening or recessed portion and the first end of the rod comprise complementary threads, and wherein the second opening or recessed portion and the second end of the rod comprise complementary threads.

12. A protective device for a disc brake rotor of a vehicle, comprising:
a cover having an end wall and a side wall extending from the end wall, wherein the end wall comprises a first surface and a second surface opposite the first surface, and wherein the end wall includes an opening through the first surface and the second surface; and
a first cap comprising a first handle portion and a rod, wherein the rod is sized and dimensioned for placement through the opening of the cover and through at least a portion of an opening or recess of a hub of a wheel of the vehicle.

13. The protective assembly of claim 12, wherein the rod comprises a compressible material and is configured to be affixed to the opening or recess of the hub.

14. The protective assembly of claim 12, wherein an end portion of the rod comprises a first threaded portion corresponding to a second threaded portion within the first opening or recess of the hub.

15. The protective assembly of claim 12, wherein the rod comprises a first fastener component corresponding to a second fastener component of at least one of the hub and a second cap.

16. The protective assembly of claim 12, wherein the rod is sized and dimensioned to extend through the entire opening of the hub, and wherein an end portion of the rod comprises a first threaded portion corresponding to a second threaded portion of a second cap.
